(19) United States
(12) Patent Application Publication
(10) Pub. No.: US 2014/0004795 A1
(43) Pub. Date: Jan. 2, 2014

(54) ELECTRONIC APPARATUS AND NON-CONTACT COMMUNICATION CONTROL METHOD

(71) Applicant: Kabushiki Kaisha Toshiba, Tokyo (JP)

(72) Inventors: Satoshi KAWASHIMO, Ome-shi (JP); Koichi Kaji, Hidaka-shi (JP); Masao TESHIMA, Kunitachi-shi (JP)

(73) Assignee: Kabushiki Kaisha Toshiba, Tokyo (JP)

(21) Appl. No.: 13/969,073

(22) Filed: Aug. 16, 2013

Related U.S. Application Data
(63) Continuation of application No. PCT/JP2013/057927, filed on Mar. 13, 2013.

(30) Foreign Application Priority Data
Jun. 29, 2012 (JP) 2012-146889

(51) Int. Cl. H04B 5/00

(52) U.S. Cl. CPC H04B 5/00
USPC 455/41.1

(57) ABSTRACT

According to one embodiment, an electronic apparatus includes a base unit, a display unit, a non-contact communication device, and an antenna switch. The antenna switch is configured to change, responding to a change of a set position of the display unit from a first position where a display surface of the display unit and a top surface of the base unit are exposed to a second position where the display surface is exposed and the top surface is covered with a back surface of the display unit, an antenna to be used by the non-contact communication device from a first antenna disposed at the top surface to a second antenna disposed at a position in the electronic apparatus which is not covered by the display unit set in the second position.

### CROSS-REFERENCE TO RELATED APPLICATIONS

This application is a Continuation Application of PCT Application No. PCT/JP2013/057927, filed Mar. 13, 2013 and based upon and claiming the benefit of priority from Japanese Patent Application No. 2012-146889, filed Jun. 29, 2012, the entire contents of all of which are incorporated herein by reference.

### FIELD

Embodiments described herein relate generally to an electronic apparatus and a non-contact communication control method which is applied to the electronic apparatus.

### BACKGROUND

In recent years, various portable electronic apparatuses, such as a notebook-type personal computer (PC), a tablet computer, a smartphone, and a PDA, have been developed. Among these electronic apparatuses, there is an electronic apparatus which supports non-contact communication such as Near Field Communication (NFC). When an external device such as a non-contact IC card is held over the electronic apparatus by a user, non-contact communication (close proximity wireless communication) is enabled between the external device and the electronic apparatus.

In the meantime, touch-screen displays have recently been widely used. The touch-screen display is a device which can detect a touch position on the screen thereof. The user touches an object on the screen of the touch-screen display by a finger or a pen, thus being able to instruct the start of a function which is associated with the object.

Computers including touch-screen displays come in a clamshell type and a tablet type. In addition, there is a convertible tablet computer which can change its style between two styles (two modes) of the clamshell type and tablet type.

Unlike an antenna for ordinary wireless communication such as wireless LAN, an antenna for the non-contact communication such as NFC is easily affected by nearby metals. Thus, in the electronic apparatus which supports non-contact communication, it is possible that the communication capability of non-contact communication is degraded depending on the position of disposition of the antenna for non-contact communication.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating external appearances corresponding, respectively, to a clamshell mode and a tablet mode of an electronic apparatus according to an embodiment;

FIG. 2 is an exemplary view for describing the relationship between a base unit and a display unit, which are provided in the electronic apparatus of the embodiment;

FIG. 3 is an exemplary cross-sectional view of the base unit which is provided in the electronic apparatus of the embodiment;

FIG. 4 is an exemplary view for describing a process in which the style of the electronic apparatus of the embodiment transitions from the clamshell mode to the tablet mode;

FIG. 5 is an exemplary block diagram illustrating the system configuration of the electronic apparatus of the embodiment;

FIG. 6 is a view illustrating another example of the position of disposition of an antenna which is used when the electronic apparatus of the embodiment is in the tablet mode;

FIG. 7 is an exemplary view for describing an antenna switching operation which is executed by the electronic apparatus of the embodiment;

FIG. 8 is an exemplary view for describing another antenna switching operation which is executed by the electronic apparatus of the embodiment;

FIG. 9 is an exemplary flowchart illustrating the procedure of an antenna switching process which is executed by the electronic apparatus of the embodiment; and

FIG. 10 is a view for describing another example of the relationship between the base unit and the display unit, which are provided in the electronic apparatus of the embodiment.

### DETAILED DESCRIPTION

Various embodiments will be described hereinafter with reference to the accompanying drawings.

In general, according to one embodiment, an electronic apparatus includes a base unit with a top surface on which a keyboard is disposed, a display unit configured to be set in either a first position where a display surface of the display unit and the top surface are exposed, or a second position where the display surface of the display unit is exposed and the top surface is covered with a back surface of the display unit, a non-contact communication device, and an antenna switch. The antenna switch is configured to change, responding to a change of a set position of the display unit from the first position to the second position, an antenna to be used by the non-contact communication device from a first antenna to a second antenna. The first antenna is disposed at the top surface. The second antenna is disposed at a position in the electronic apparatus which is not covered by the display unit that is set in the second position.

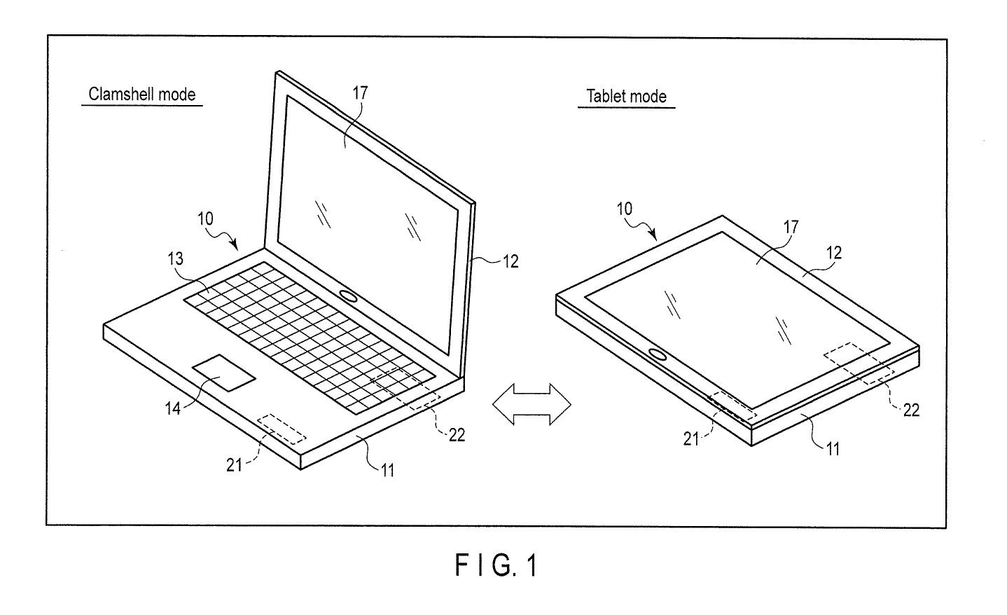

FIG. 1 illustrates external appearances corresponding, respectively, to a clamshell mode and a tablet mode of an electronic apparatus according to an embodiment. This electronic apparatus is realized, for example, as a convertible tablet computer 10. The convertible tablet computer 10 is used in a style corresponding to either a clamshell mode illustrated in a left part of FIG. 1 or a tablet mode illustrated in a right part of FIG. 1.

The convertible tablet computer 10 includes a base unit 11 and a display unit 12. The base unit 11 includes a thin, rectangular housing, which accommodates a CPU, a memory, and other various electronic components. A keyboard 13 and a touchpad 14 are disposed on a top surface of the base unit 11.

Further, a first antenna 21 for non-contact communication (close proximity wireless communication) is disposed at the top surface of the base unit 11. The first antenna 21 is disposed, for example, at a palm rest area of the top surface of the base unit 11. To be more specific, the first antenna 21 is provided within the base unit 11 such that the first antenna 21 is opposed to a part of the palm rest area of the top surface of the base unit 11. The part of the palm rest area, which is opposed to the first antenna 21, functions as a non-contact communication part.

A touch-screen display 17 is disposed on a front surface of the display unit 12, that is, on a display surface of the display unit 12. The touch-screen display 17 is configured to detect the position of a pen or a finger on the display 17.

The display unit 12 is set in either a first position corresponding to the style of the clamshell mode illustrated in the left part of FIG. 1, or a second position corresponding to the style of the tablet mode illustrated in the right part of FIG. 1. To be more specific, the display unit 12 is set in either the first position in which the display surface of the display unit 12 and the top surface of the base unit 11 are exposed, or the second position in which the display surface of the display unit 12 is exposed and the top surface of the base unit 11 is covered with a back surface of the display unit 12.

In the clamshell mode, the convertible tablet computer 10 is mainly used in the state in which the convertible tablet computer 10 is placed on a horizontal plane such as a top surface of a desk. In the clamshell mode, a user mainly operates the keyboard 13. Further, in the clamshell mode, the above-described first antenna 21 is used as the antenna for non-contact communication. The user can execute non-contact communication between the convertible tablet computer 10 and an external device by holding the external device, which is, for instance, a non-contact IC card, a non-contact reader/writer or some other kind of device having a non-contact communication function, over the non-contact communication part of the palm rest area, or by placing the external device on the non-contact communication part of the palm rest area.

On the other hand, in the tablet mode, the convertible tablet computer 10 is mainly used in the state in which the convertible tablet computer 10 is held by one hand or both hands of the user. The user performs a touch operation on the display 17, mainly by a pen or a finger. In the tablet mode, the above-described first antenna 21 is covered with the display unit 12. Further, due to metals in the display unit 12, the capability of the first antenna 21 is lowered. Thus, in the present embodiment, when the style of the convertible tablet computer 10 has been changed from the clamshell mode to the tablet mode, the antenna that is used for non-contact communication is automatically switched from the first antenna 21 to a second antenna 22. The second antenna 22 is disposed at a position in the computer 10, which is other than the top surface of the base unit 11, that is, at a certain position in the computer 10, which is not covered with the display unit 12 in the tablet mode.

In FIG. 1, the second antenna 22 is disposed on a bottom surface of the base unit 11. To be more specific, the second antenna 22 is provided in the base unit 11 such that the second antenna 22 is opposed to an upper right part of the bottom surface of the base unit 11. A part of the bottom surface, which is opposed to the second antenna 22, functions as a non-contact communication part. As has been described above, in the tablet mode, the convertible tablet computer 10 is mainly used in the state in which the convertible tablet computer 10 is held by one hand or both hands of the user. In the state in which the user holds the convertible tablet computer 10 by the hand(s), the user puts the upper right part of the bottom surface of the base unit 11 over the non-contact communication part of the external device. Thereby, the non-contact communication between the external device and the computer 10 can be executed.

In the clamshell mode, in many cases, the convertible tablet computer 10 is used in the state in which the convertible tablet computer 10 is placed on the desk, as described above. If the desk is formed of a metal, it is possible that the communication capability of the second antenna 22, which is disposed on the bottom surface of the base unit 11, is greatly lowered. However, in the tablet mode, in many cases, the convertible tablet computer 10 is used in the state in the convertible tablet computer 10 is held by the hand(s). Therefore, the possibility is low that the capability of the second antenna 22, which is disposed on the bottom surface of the base unit 11, is degraded by the metallic desk.

Furthermore, the second antenna 22 has a larger size than the first antenna 21. Thereby, the second antenna 22 has a higher sensitivity than the first antenna 21.

As described above, while the convertible tablet computer 10 is in the clamshell mode, the external device can be placed on the non-contact communication part of the palm rest area. Thus, the possibility is low that a positional displacement between the convertible tablet computer 10 and the external device occurs during non-contact communication, and stable non-contact communication can be executed therebetween.

On the other hand, while the convertible tablet computer 10 is in the tablet mode, as described above, the user performs an operation of putting the upper right part of the bottom surface of the base unit 11 over the non-contact communication part of the external device, while holding the convertible tablet computer 10 by the hand(s). Thus, the convertible tablet computer 10 executes non-contact communication with the external device in a relatively unstable state. In the embodiment, since the second antenna 22 has a higher sensitivity than the first antenna 21, the convertible table computer 10 can execute stable non-contact communication between the external device and the computer 10 even when the computer 10 is in the tablet mode.

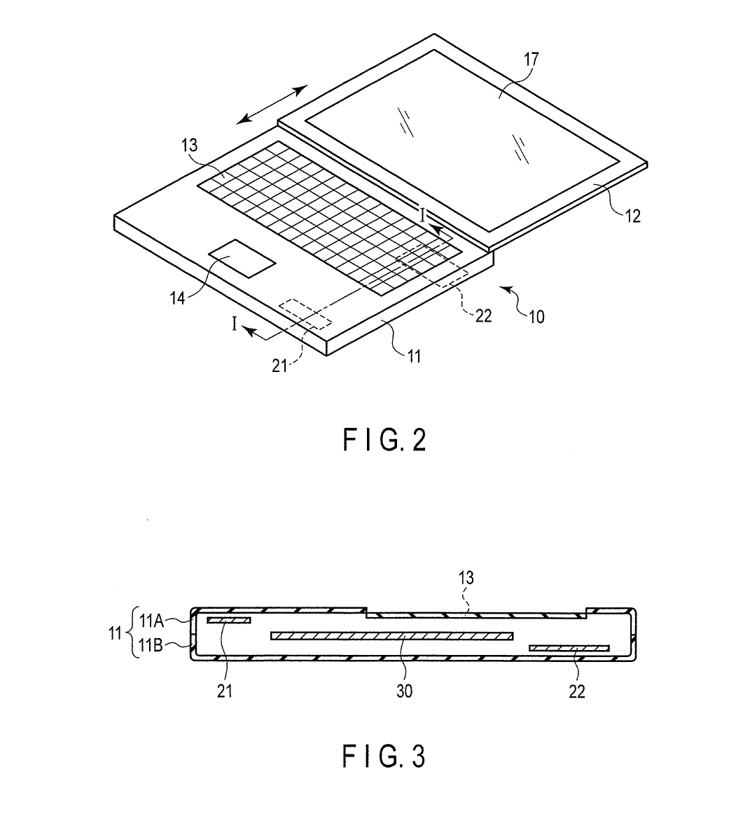

FIG. 2 shows an example of the relationship between the base unit 11 and the display unit 12. The display unit 12 is attached to a rear end portion of the base unit 11 such that the display surface of the display unit 12 may become substantially parallel to the top surface of the base unit 11, that is, such that the display unit 12 may be opened over about 180°. Further, the display unit 12 is attached to the base unit 11 such that the display unit 12 can move (slide) between the front end portion and rear end portion of the base unit 11. In the state in which the display unit 12 is opened over about 180°, the display unit 12 can be freely slid between the front end portion and rear end portion of the base unit 11. In the state shown in FIG. 2, the display unit 12 is slid toward the front end portion of the base unit 11 so that the lower end portion of the display unit 12 may reach the front end portion of the base unit 11. Thereby, the computer 10 can be set in the tablet mode. In addition, in the state shown in FIG. 2, the display unit 12 is made to stand up, and thereby the computer 10 can be set in the clamshell mode.

FIG. 3 is a cross-sectional view of the base unit 11, taken along line I-I in FIG. 2. The housing of the base unit 11 includes an upper casing 11A and a lower casing 11B. The above-described first and second antennas 21 and 22 are provided in the housing of the base unit 11.

The first antenna 21 includes, for example, a dielectric board, and a coil-shaped wiring pattern which is disposed on the dielectric board. The first antenna 21 is disposed near an inner surface of the upper casing 11A such that the wiring pattern is opposed to the inner surface of the upper casing 11A, that is, near an upper wall of the base unit 11.

The second antenna 22 also includes, for example, a dielectric board, and a coil-shaped wiring pattern which is disposed on the dielectric board. The second antenna 22 is disposed near an inner surface of the lower casing 11B such that the wiring pattern is opposed to the inner surface of the lower casing 11B, that is, near a bottom wall of the base unit 11.

In addition, a printed circuit board 30, on which various electronic components are mounted, is provided within the housing of the base unit 11.

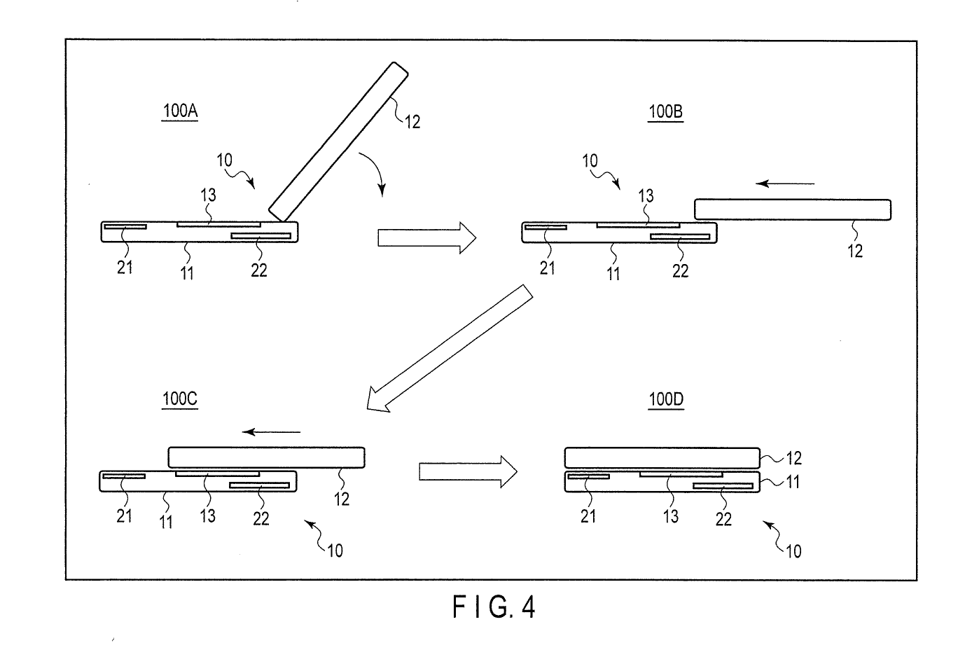

FIG. 4 illustrates a process in which the style of computer 10 transitions from the clamshell mode to the tablet mode. In FIG. 4, 100A illustrates the above-described clamshell mode. 100B illustrates a state in which the display unit 12 of the computer 10, which is in the clamshell mode, is opened over about 180°. 100C illustrates a state in which the display 12, which is opened over about 180°, is slid toward the front end portion of the base unit 11. 100D illustrates the above-described tablet mode.

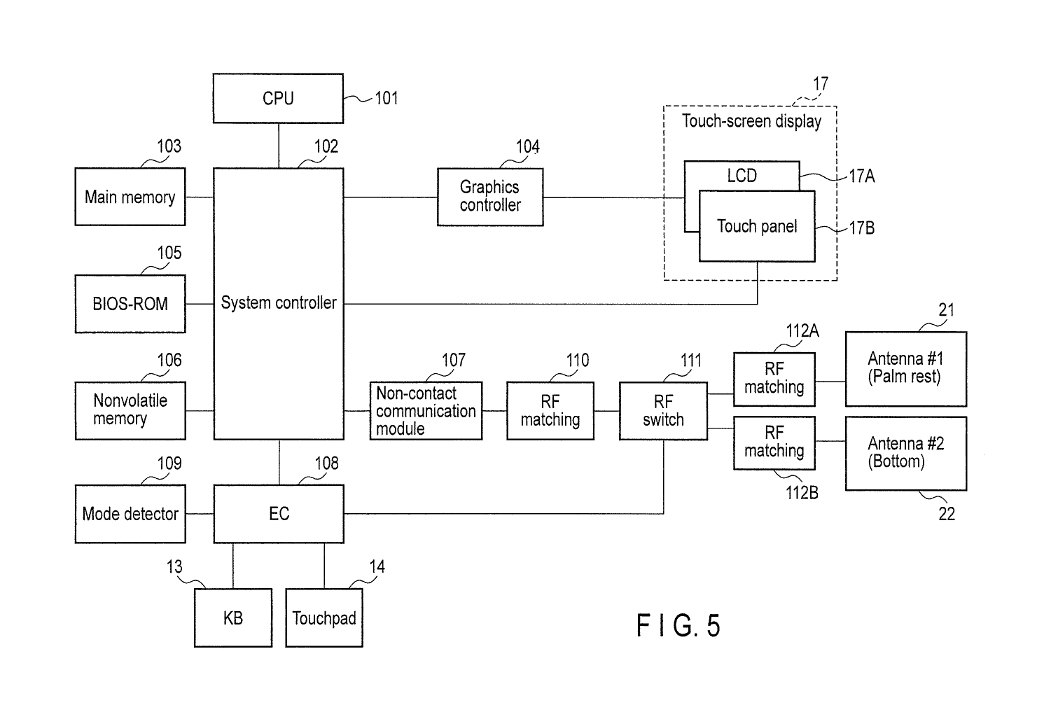

FIG. 5 illustrates the system configuration of the computer 10.

The computer 10 includes, in addition to the above-described keyboard 13, touchpad 14 and first and second antennas 21 and 22, a CPU 101, a system controller 102, a main memory 103, a graphics controller 104, a BIOS-ROM 105, a nonvolatile memory 106, a non-contact communication module 107, an embedded controller (EC) 108, a mode detector 109, an RF matching circuit 110, an RF switch 111, an RF matching circuit 112A, and an RF matching circuit 112B.

The CPU 101 is a processor which controls the operations of the respective components in the computer 10. The CPU 101 executes various kinds of software, which are loaded from the nonvolatile memory 106 into the main memory 103. The software includes an operating system (OS) and various application programs. In addition, the CPU 101 executes a basic input/output system (BIOS) which is stored in the BIOS-ROM 105. The BIOS is a program for hardware control.

The system controller 102 is connected to a local bus of the CPU 101. The system controller 102 includes a memory controller which access-controls the main memory 103. In addition, the system controller 102 includes a function of communicating with the graphics controller 104 via, e.g. a PCI EXPRESS serial bus.

The graphics controller 104 is a display controller which controls an LCD 17A that is used as a display monitor of the computer 10. A display signal, which is generated by the graphics controller 104, is sent to the LCD 17A. The LCD 17A displays an image based on the display signal. A touch panel 17B is disposed on the LCD 17A. The touch panel 17B is a pointing device for executing an input on the screen of the LCD 17A. Using the touch panel 17B, the user can operate, e.g. a graphical user interface (GUI) which is displayed on the screen of the LCD 17A. For example, by touching a button displayed on the screen, the user can instruct execution of a function corresponding to the button.

The system controller 102 incorporates an ATA controller for controlling the nonvolatile memory 106. The nonvolatile memory 106 is realized by a semiconductor storage device such as an SSD.

The non-contact communication module 107 is a non-contact communication device which is configured to execute non-contact communication with an external device. In some cases, the non-contact communication is called “close proximity wireless communication”. NFC, for instance, is used as the non-contact communication. A radio-frequency signal (RF signal) input/output terminal of the non-contact communication module 107 is connected to the RF switch 111 via the RF matching circuit 110. The RF switch 111 is an antenna switch which is configured to switch an antenna, which is connected to the non-contact communication module 107, between the first antenna 21 and the second antenna 22. In accordance with a control signal which is delivered from the EC 108, the RF switch 111 switches the antenna, which is connected to the non-contact communication module 107, between the first antenna 21 and second antenna 22.

In the present embodiment, in accordance with the present style of the computer 10, the antenna, which is connected to the non-contact communication module 107, is automatically switched between the first antenna 21 and second antenna 22. Specifically, responding to the change of the set position of the display unit 12 from the above-described first position to the above-described second position, that is, responding to the change from the clamshell mode to the tablet mode, the RF switch 111 switches the antenna, which is used by the non-contact communication module 107, from the first antenna 21 to the second antenna 22. In addition, responding to the change of the set position of the display unit 12 from the second position to the first position, that is, responding to the change from the tablet mode to the clamshell mode, the RF switch 111 switches the antenna, which is used by the non-contact communication module 107, from the second antenna 22 to the first antenna 21.

The RF matching circuit 112A, which is configured to adjust the impedance of the first antenna 21, is connected between the RF switch 111 and the first antenna 21. Similarly, the RF matching circuit 112B, which is configured to adjust the impedance of the second antenna 22, is connected between the RF switch 111 and the second antenna 22. The RF matching circuits 112A and 112B, together with other various components, may be mounted on the printed circuit board. Alternatively, the RF matching circuit 112A may be disposed in the first antenna 21, and the RF matching circuit 112B may be disposed in the second antenna 22.

The distance from the non-contact communication module 107 to the first antenna 21 and the distance from the non-contact communication module 107 to the second antenna 22 are different from each other. In addition, in some cases, the resonance frequency of the first antenna 21 in the clamshell mode slightly deviates from a desired frequency, owing to a variation in the effect of nearby metals upon the first antenna 21, this variation occurring due to, e.g. a variance in assembly of the computer 10. Similarly, in some cases, the resonance frequency of the second antenna 22 in the tablet mode slightly deviates from a desired frequency, owing to a variation in the effect of nearby metals upon the second antenna 22, this variation occurring due to, e.g. a variance in assembly of the computer 10.

In the present embodiment, the impedances of the first antenna 21 and second antenna 22 can be individually adjusted by the RF matching circuits 112A and 112B. Accordingly, even in the case where the effect of nearby metals upon the first antenna 21 and the effect of nearby metals upon the second antenna 22 are different, the resonance frequencies of the first antenna 21 and second antenna 22 can be set at desired frequencies by individually adjusting the impedances of the first antenna 21 and second antenna 22. Therefore, stable non-contact communication can be realized in each of the case where the style corresponding to the clamshell mode is used and the case where the style corresponding to the tablet mode is used.

The EC 108 is a one-chip microcomputer including an embedded controller for power management. The EC 108 includes a function of powering on or powering off the computer 10 in accordance with an operation of a power button by the user. In addition, the EC 108 includes a keyboard controller which is configured to control the keyboard 13 and touchpad 14.

The mode detector 109 is a detector configured to detect whether the present style of the computer 10 is the clamshell mode or the tablet mode. The mode detector 109 may be disposed, for example, at a front end portion on the top surface of the base unit 11. In this case, the mode detector 109 can determine whether the present style is the clamshell mode or the tablet mode, according to whether the front end portion on the top surface of the base unit 11 is in contact with the back surface of the display unit 12.

By using the mode detector 109, the EC 108 detects a change of the set position of the display unit 12 from the above-described first position to the above-described second position. Then, responding to the detection of the change of the set position of the display unit 12 from the first position to the second position, the EC 108 controls the RF switch 111 and changes the antenna, which is used by the non-contact communication device, from the first antenna 21 which is disposed at the top surface of the base unit 11, to the second antenna 22 disposed at a position which is not covered by the display unit 12 that is set in the second position.

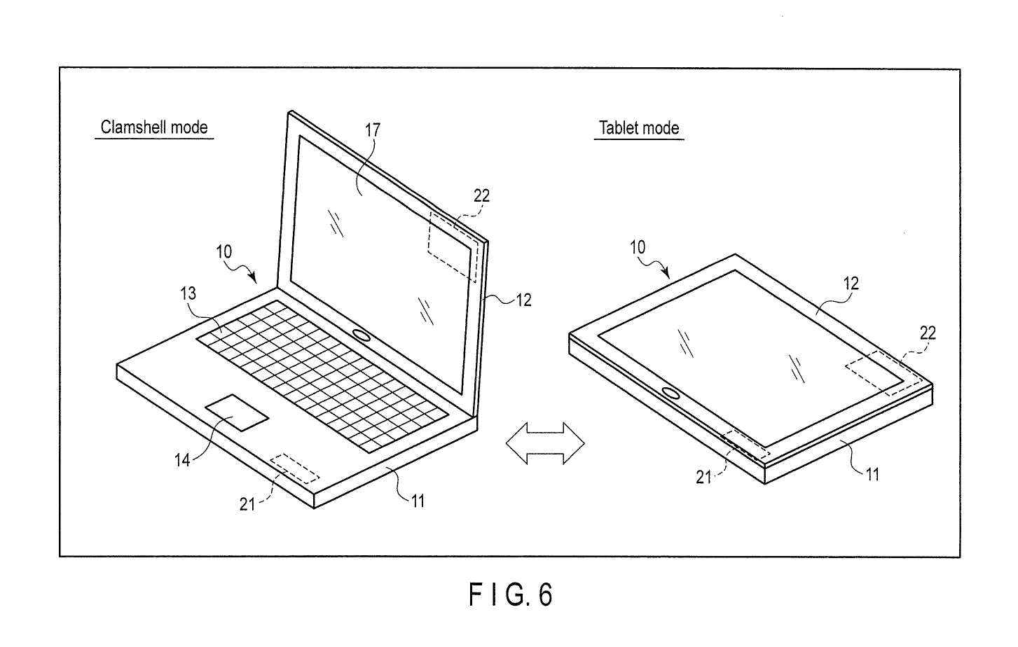

FIG. 6 illustrates another example of the position of disposition of the second antenna 22. In FIG. 6, the second antenna 22 is disposed within the display unit 12 such that the second antenna 22 is opposed to the display surface of the display unit 12. Specifically, the second antenna 22 is disposed within the display unit 12 in the state in which the second antenna 22 is opposed to, for example, an upper right area of the display surface of the display unit 12 so that the upper right area of the display surface of the display unit 12 may function as a non-contact communication part (non-contact communication detection area).

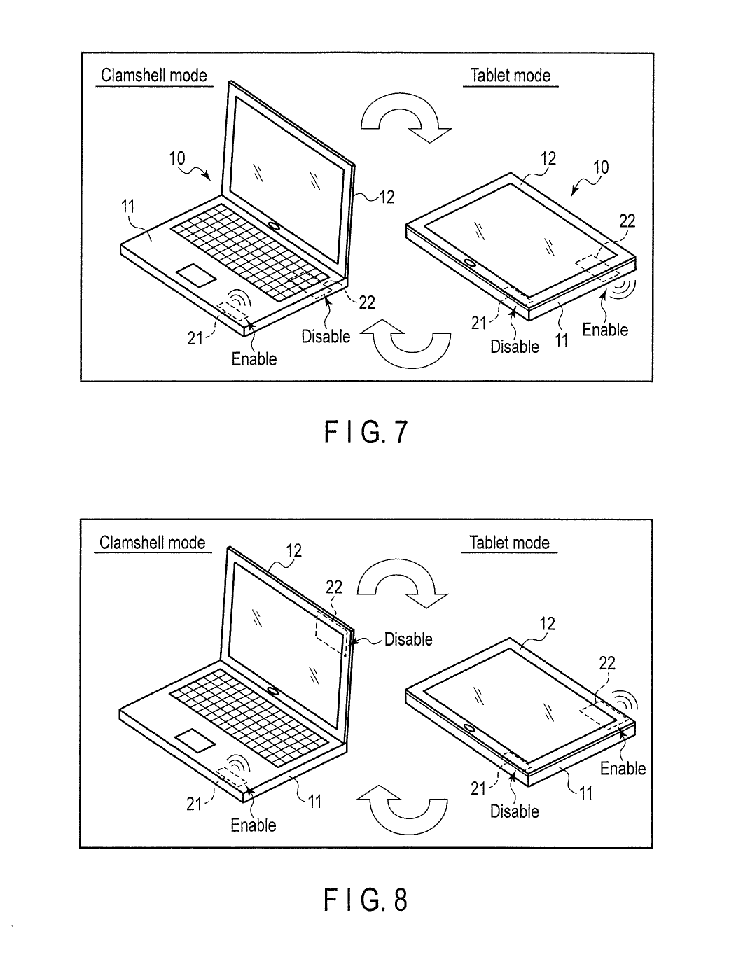

FIG. 7 is an exemplary view for describing an antenna switching operation in the embodiment. In FIG. 7, the case is assumed that the first antenna 21 is disposed at the palm rest area and the second antenna 22 is disposed at the bottom surface of the base unit 11.

In the clamshell mode, the RF switch 111, under the control of the EC 108, enables the first antenna 21 and disables the second antenna 22. In this case, the first antenna 21 is selected by the RF switch 111, and the first antenna 21 is electrically connected to the non-contact communication module 107. The second antenna 22 is electrically disconnected from the non-contact communication module 107.

When the change of the style of the computer 10 to the tablet mode has been detected by the mode detector 109, the RF switch 111, under the control of the EC 108, enables the second antenna 22 and disables the first antenna 21. In this case, the second antenna 22 is selected by the RF switch 111, and the second antenna 22 is electrically connected to the non-contact communication module 107. The first antenna 21 is electrically disconnected from the non-contact communication module 107.

In the meantime, in the case where the computer 10 is in the clamshell mode as shown in a left part of FIG. 7, it may be possible to disable the second antenna 22 by changing an RF matching constant, which is set in the RF matching circuit 112B corresponding to the second antenna 22, to a constant at which communication is disabled, and to enable the first antenna 21 by changing an RF matching constant, which is set in the RF matching circuit 112A corresponding to the first antenna 21, to a constant at which communication is enabled.

FIG. 8 also is an exemplary view for describing the antenna switching operation in the embodiment. In FIG. 8, the case is assumed that the first antenna 21 is disposed at the palm rest area and the second antenna 22 is disposed in the display unit 12 such that the second antenna 22 is opposed to the display surface of the display unit 12.

In the clamshell mode, the RF switch 111, under the control of the EC 108, enables the first antenna 21 and disables the second antenna 22. When the change of the style of the computer 10 to the tablet mode has been detected by the mode detector 109, the RF switch 111, under the control of the EC 108, enables the second antenna 22 and disables the first antenna 21.

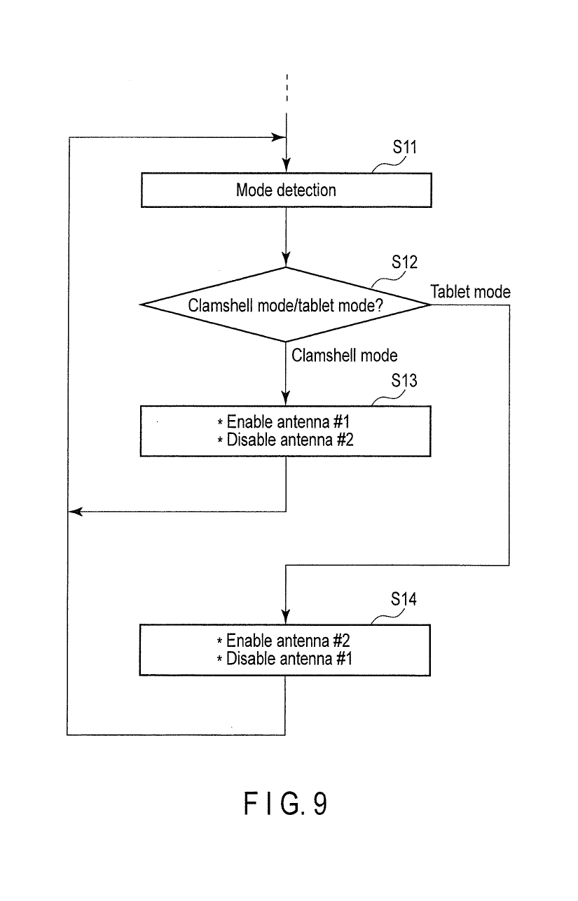

Next, referring to a flowchart of FIG. 9, a description is given of the procedure of an antenna switching process which is executed by the computer 10.

The computer 10 determines, by using the mode detector 109, whether the computer 10 is set in the clamshell mode or tablet mode, that is, whether the display unit 12 is set in the above-described first position or in the above-described second position (step S11, S12). In the case where the mode detector 109 is configured to only detect whether the display unit 12 is set in the above-described second position or not, as described above, it may be determined that the computer 10 is in the tablet mode if the mode detector 109 is “ON”, that is, if the mode detector 109 detects that the display unit 12 is set in the second position, and it may be determined that the computer 10 is in the clamshell mode if the mode detector 109 is “OFF”, that is, if the mode detector 109 does not detect that the display unit 12 is set in the second position.

When the computer 10 is in the clamshell mode, the computer 10 selects, by the RF switch 111, the first antenna 21 from the first and second antennas 21 and 22, and electrically connects the first antenna 21 to the non-contact communication module 107 (step S13). Thereby, the first antenna 21 is enabled and the second antenna 22 is disabled.

On the other hand, when the computer 10 is in the tablet mode, the computer 10 selects, by the RF switch 111, the second antenna 22 from the first and second antennas 21 and 22, and electrically connects the second antenna 22 to the non-contact communication module 107 (step S14). Thereby, the second antenna 22 is enabled and the first antenna 21 is disabled.

In the above description, the case is assumed that the display unit 12 is attached to the base unit 11 such that the display unit 12 slides over the base unit 11. However, the structure for coupling the display unit 12 and the base unit 11 is not limited to this example.

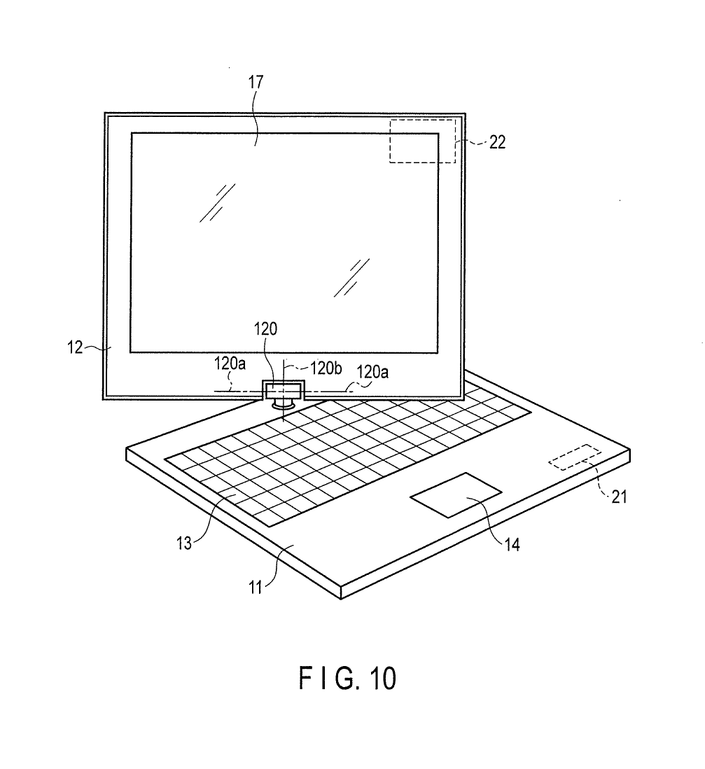

For example, in FIG. 10, the display unit 12 is rotatably attached to the base unit 11 via a hinge module 120. The hinge module 120 has two axes, namely a first axis 120a extending in parallel to the top surface of the base unit 11, and a second axis 120b extending perpendicular to the first axis 120a. The display unit 12 is attached to the base 11 such that the display unit 12 rotates about the first axis 120a. In other words, the display unit 12 can rotate about the first axis 120a between an open position where the top surface of the base unit 11 is exposed and a closed position where the top surface of the base unit 11 is covered with the display surface of the display unit 12. In addition, the display unit 12 can rotate about the second axis 120b over 180°. In other words, the display unit 12 can rotate about the second axis 120b between a first position where the display surface of the display unit 12 faces the front side of the computer 10 (the rotational angle of the display unit 12 is 0°) and a second position where the back surface of the display unit 12 faces the front side of the computer 10 (the rotational angle of the display unit 12 is 180°).

The state in which the display unit 12 is rotated about the second axis 120b over 180° and the display unit 12 is closed, that is, the state in which the display unit 12 is set in the position where the back surface of the display unit 12 covers the top surface of the base unit 11, corresponds to the above-described tablet mode.

As has been described above, according to the present embodiment, responding to the change of the set position of the display unit 12 from the first position to the second position, the antenna that is to be used by the non-contact communication module 107 is changed from the first antenna 21, which is disposed at the top surface of the base unit 11, to the second antenna 22 that is disposed at that position in the computer 10, which is not covered by the display unit 12 that is set in the second position. Accordingly, since the antenna that is used for non-contact communication can automatically be changed in accordance with the present style of the computer 10, the non-contact communication can effectively be used, regardless of whether the present style of the computer 10 is the clamshell mode or the tablet mode. Incidentally, the second antenna 22 may be disposed on a side surface of the base unit 11.

The configuration of the present embodiment is applicable not only to the tablet computer, but also to various electronic apparatuses, such as a smartphone and a PDA, which can use both the clamshell mode and tablet mode.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a base unit with a top surface on which a keyboard is disposed;
a display unit configured to be set in either a first position where a display surface of the display unit and the top surface are exposed, or a second position where the display surface of the display unit is exposed and the top surface is covered with a back surface of the display unit;
a non-contact communication device; and
an antenna switch configured to change, responding to a change of a set position of the display unit from the first position to the second position, an antenna to be used by the non-contact communication device from a first antenna to a second antenna, the first antenna being disposed at the top surface, the second antenna being disposed at a position in the electronic apparatus which is not covered by the display unit that is set in the second position.

2. The electronic apparatus of claim 1, wherein the second antenna has a larger size than the first antenna.

3. The electronic apparatus of claim 1, wherein the second antenna is disposed at a bottom surface of the base unit.

4. The electronic apparatus of claim 1, wherein the second antenna is disposed within the display unit such that the second antenna is opposed to the display surface of the display unit.

5. The electronic apparatus of claim 1, wherein the display unit comprises a touch-screen display.

6. A non-contact communication control method which is applied to an electronic apparatus comprising a base unit with a top surface on which a keyboard is disposed, and a display unit configured to be set in either a first position where a display surface of the display unit and the top surface are exposed, or a second position where the display surface of the display unit is exposed and the top surface is covered with a back surface of the display unit, the method comprising:
detecting a change of a set position of the display unit from the first position to the second position; and
changing, responding to the detection of the change of the set position of the display unit, an antenna to be used by a non-contact communication device in the electronic apparatus from a first antenna to a second antenna, the first antenna being disposed at the top surface, the second antenna being disposed at a position in the electronic apparatus which is not covered by the display unit that is set in the second position.

7. The non-contact communication control method of claim 6, wherein the second antenna has a larger size than the first antenna.

8. The non-contact communication control method of claim 6, wherein the second antenna is disposed at a bottom surface of the base unit.

9. The non-contact communication control method of claim 6, wherein the second antenna is disposed within the display unit such that the second antenna is opposed to the display surface of the display unit.
